(19) United States
(12) Patent Application Publication
(10) Pub. No.: US 2007/0296267 A1
(43) Pub. Date: Dec. 27, 2007

(54) APPARATUS FOR BRAKING SYSTEMS OF ARTICULATED VEHICLES

(76) Inventors: Neil Edward Walker, Cheshire (GB); Robert Tonge, Cheshire (GB)

Correspondence Address: SCHWEGMAN, LUNDBERG & WOESSNER, P.A., P.O. BOX 2938, MINNEAPOLIS, MN, 55402, US

(21) Appl. No.: 11/759,147

(22) Filed: Jun. 6, 2007

Related U.S. Application Data
(63) Continuation of application No. PCT/GB05/04548, filed on Nov. 30, 2005.

(30) Foreign Application Priority Data
Dec. 3, 2004 (GB) 0426588.0

(51) Int. Cl. B60T 7/20

(52) U.S. Cl. 303/15

(57) ABSTRACT

The present application describes a valve or valve assembly for inclusion in an emergency air supply line to the trailer braking system of an articulated vehicle. The valve or valve assembly has an air inlet, an air outlet, a closing member, and an operating means. The air inlet is connectable to an upstream side of the emergency air supply line. The air outlet is connectable to a downstream side of the emergency air supply line. The closing member is biased towards a closed position in which passage of air through the valve between the first air inlet and first air outlet is substantially prevented. The operating means opens the closing member. The valve or valve assembly also includes control means for retaining the closing member in an open position on receipt of an electrical signal, the signal being derived from an electrical braking system of the vehicle.

### TECHNICAL FIELD

This present application relates generally to to braking systems of articulated vehicles.

### BACKGROUND

In the braking systems of articulated vehicles, there are typically two airlines which supply air under high pressure from the tractor unit to the trailer: the “yellow line” or “service line” and the “red line” or “emergency line”.

Air is supplied along the yellow line only when a brake pedal in the tractor unit is depressed by the driver. This air is supplied to air chambers in the trailer, one air chamber typically being associated with each wheel or set of wheels of the trailer. Increased air pressure in an air chamber causes a cam brake to brake the corresponding wheel. The brakes are then released when air supply along the yellow line is terminated, when the brake pedal is released. This will be referred to herein as the “service braking system”.

In addition to the air chambers, the trailer has an air tank, which normally contains air under high pressure. Air may be released from this tank via a valve, to the air chambers, in order to activate the trailer brakes independently of the yellow line. In normal operation, the red line supplies air under high pressure to the valve in the air tank, keeping the valve closed, so that the trailer brakes are not activated by release of air from the tank.

If the supply of air along the red line is interrupted and pressure in the red line falls, the valve in the air tank is no longer kept closed and air is supplied from the tank to the air chambers to activate the trailer brakes. In particular, air supply along the red line is interrupted when a connector in the red line between the tractor unit and trailer is disconnected when the tractor unit and trailer are uncoupled, with the result that the trailer brakes are automatically applied when the trailer is loose from the tractor unit.

When the air supply along the red line is restored, for example when the connector between the trailer and tractor unit is reconnected, the valve in the air tank is closed and an exhaust valve is opened, thus allowing air to escape from the air chambers and the trailer brakes to be released, so that the system returns to its pre-interruption state. This will be referred to herein as the “emergency braking system”.

A problem with such an emergency braking system, however, is that the combination of trailer and tractor unit can become free-wheeling if the handbrake of a tractor unit has not been applied before reconnecting the connector in the red line between trailer and tractor unit on coupling the trailer and tractor unit. Because the trailer is braked prior to reconnection by the emergency braking system, it is a simple error for a driver to move the tractor unit into position relative to the trailer and then rely on the trailer brakes to keep both the tractor unit and trailer stationary during the coupling operation, forgetting that during this operation the emergency braking system will be deactivated, releasing the trailer brakes. Many costly and some fatal accidents have occurred because of this simple human error.

### BRIEF DESCRIPTION OF THE DRAWINGS

FIG. 1 shows in cross-section a valve according to GB2341662;

FIG. 2 shows a schematic diagram showing a valve according to an embodiment of the present invention connected to a part of a vehicle braking system.

FIG. 3 shows a schematic cross-sectional view through the main valve body of FIG. 2.

### SUMMARY

A previous system incorporated a valve arrangement which did not permit the red line to be activated (i.e. brakes released until the yellow line was activated, the driver had applied the footbrake). The valve then remained in its operating position by air pressure in the red line. However, it is possible that if the red line becomes inoperable (for example, due to an accident or breakdown), it could be difficult or impossible to release the emergency braking system in order to move the trailer.

Accordingly, embodiments described herein provide a valve or valve assembly for inclusion in an emergency air supply line to the trailer braking system of an articulated vehicle. The valve or valve assembly has an air inlet, an air outlet, a closing member, operating means, and control means. The air inlet is connectable to an upstream side of the emergency air supply line. The air outlet is connectable to a downstream side of the emergency air supply line. The closing member is biased towards a closed position in which passage of air through the valve between the first air inlet and first air outlet is substantially prevented. The operating means opens the closing member. The control means is for retaining the closing member in an open position on receipt of an electrical signal. The signal is derived from an electrical braking system of the vehicle. Hereinafter, for convenience only, the air inlet may also be referred to as the “red inlet” and the air outlet as the “red outlet”, and the normal brake line as the “yellow” line.

As with GB2341662, when such a valve is included in the emergency air supply line to a trailer braking system, the emergency braking system is not deactivated automatically when the emergency line is connected, by virtue of the closing member being biased towards a closed position which prevents passage of air through the valve. Rather, the emergency braking system is deactivated only when the operating means are activated, e.g., by operation of the foot brake and, activation of service air supply line. This of course has the effect that the trailer is still braked when the emergency braking system is released. Thus the trailer cannot become free-wheeling when the emergency line is connected. Preferably, the emergency braking system can also only be deactivated if the control means is activated i.e. is receiving an electrical signal.

However, in GB2341662 the closing member is then retained in an open position by air pressure in the emergency line, to keep the emergency braking system in a deactivated state until the pressure in the emergency line is reduced e.g. by disconnection of the line.

By contrast, the present invention includes control means for retaining the closing member in an open position and these means are kept activated by an appropriate electrical signal even once, e.g. the foot/hand brake is released. This provides the advantage that the valve does not automatically close if the pressure in the red line falls for any reason, for example in an accident or breakdown. When the pressure in the red line falls, the emergency brakes are of course applied but, in the prior art, it could be difficult if not impossible to then subsequently release the emergency brakes, even temporarily. With the present invention, as long as the electrical supply has been maintained to the control means, it will be possible to release the emergency brakes by raising the pressure in the red line in the usual way, without necessarily having to apply the normal brakes first.

The valve may be included at any position along the emergency line, e.g. preferably on the trailer side. For convenience of retrofitting to existing vehicles, the valve can be included near the point at which the tractor unit and trailer sides of the line are connected when the tractor unit and trailer are coupled. As stated, the electrical signal is derived (directly or indirectly from an electrical braking system, such as an item of braking assistance equipment e.g. an ABS or EBS brake system. This has the further advantage that if for any reason the braking system is not working (i.e. not powered) the opening means cannot be operated and therefore the emergency brakes cannot be released. This provides an additional safeguard.

In practice, the ABS or EBS brake system receives a permanent power supply from the tractor unit i.e. there is an electrical connection (sometimes known as the ABS or EBS lead) between the tractor and trailer which needs to be connected in the same way that the red and yellow lines are connected when the tractor and trailer are coupled together. When the control means is mounted on the trailer side, since it derives its electrical power from the braking system as described, this means that if e.g. ABS/EBS lead is not connected then the control means will receive no power and the brakes cannot be released. In other words, if the ABS/EBS braking system has not been properly activated, the trailer cannot be removed. Clearly this is an important safety advantage.

When it is stated that the signal for the control means is “derived” from an electrical braking system of the vehicle, as stated above this “derivation” could be direct or indirect i.e. it is not necessary that the signal comes straight from some part of the electrical braking system. In some embodiments, as will be seen in the specific description below, power from a part of the electrical braking system is connected to a pressure switch is located in the yellow line of the system. Not only does this power the pressure switch, but it is a convenient place from which the signal can be taken to the control means.

Preferably, the control means requires a repeated, continuous, or substantially continuous signal in order to remain activated i.e. to retain the closing member in an open position.

Preferably, the valve also includes start means which are activatable to operate the operating means open the closing member) on activation of a foot or hand brake of the vehicle.

The start means are electrically operated, unlike the arrangement in GB2341662. The electrical supply which operates the start means may be taken from a pressure switch which is operated, for example, by pressure to the yellow (normal braking) line.

The start means may include opening valve means (which may be one way and the whole may be arranged so that when the start means is operated by a suitable electrical supply, the opening valve means open to permit air pressure to pass from the red line to the operating means. The operating means may be operated by suitable pressure and may remain operated as long as suitable pressure is applied. The operating means may incorporate a piston which is movable by pressure to operate the closing member, and thereby to open the closing member.

The valve may include a further pressure supply means connected to or connectable to the air outlet or the downstream side of the emergency air supply line. This further pressure supply means serves to permit pressure in the downstream side of the air supply line to be applied to the operating means in order to keep the operating means operating (i.e. keep the closing member open) during operation of the vehicle.

During normal operation of the vehicle, the foot or hand brakes will of course not be applied most of the time and therefore the start means will not be operational, since the start means will not be receiving an electrical supply from e.g. the pressure switch. Were it not for the further pressure supply means, there would therefore be no pressure being applied to the opening means in order to keep the closing member in the open position.

Preferably the control means also includes a control valve which in use connects the air outlet or the downstream side of the emergency air supply line to the opening means. While electrical power is supplied to the control means the control valve remains closed, thereby preventing pressure from escaping from the operating means. Thus even if the pressure in the downstream side of the emergency air supply line falls (and therefore the emergency brakes are applied) the control valve remains closed and the pressure remains applied to the operating means so that the closing member remains open. In this way, if pressure can be reintroduced into the emergency supply line (by various normal operating techniques), the emergency brakes can be released when necessary. However, if the electrical power to the control means has been removed (e.g. by switching off the ignition or removing the ABS plug, or lead), the control valve will have opened and pressure will have escaped from the operating means, thereby allowing the closing member to close. At that stage, the only way to release the emergency brakes will be to go through the normal start up procedure.

Preferably the control means prevents the operating means from operating the closing member if the control means is not activated i.e. if it is not receiving electrical power. This helps to prevent the brakes being released if, for example, the ignition is not on.

Preferably, the closing member includes a second piston movable in a second chamber of the valve, the second chamber lying between the red inlet and red outlet. More preferably, the red inlet and red outlet are spaced apart in the direction of movement of the second piston. When the second piston is in its closed position, this feature allows the red inlet and red outlet to be isolated by a seal between the second piston and a wall of the chamber.

Preferably the closing member is spring biased towards the closed position, more preferably by a compression spring.

Preferably, an actuator for the closing member is connected to the piston in the opening means, which may be slidable in a second chamber of the valve.

Desirably, movement of the actuator is imparted to the closing member via a link. More desirably, the piston and actuator are in line, movement being imparted by the link along that line. Alternatively, however, in some embodiments the link could be pivoted. It is also possible that movement of the actuator could be imparted to the closing member hydraulically.

The valve may include an override, operable (desirably manually) to move the closing member into the open position in case of failure of the actuator to do so. Such an override may be lockable, to keep the closing member in the open position. Such a feature allows the valve to be completely disabled, and the emergency braking system will then function as if no valve were present.

The valve may include a bypass which, when the closing member is in its closed position, allows air to escape from the trailer side (i.e. downstream side) of an emergency air supply line connected to the valve. Such a bypass eliminates the possibility that by moving very rapidly to its closed position upon initial reduction of pressure in the red line, the closing member may prevent sufficient reduction in pressure on the trailer side of the valve to activate the emergency braking system.

A bypass may be provided by configuring the valve such that when the closing member is in the closed position, the red outlet is in communication with an exhaust outlet. In such an embodiment, the closing member must of course prevent communication between either the red inlet or the red outlet and the exhaust outlet, when it is in the closed position.

From a second aspect, the present invention provides a system for safely deactivating an emergency braking system of a trailer an articulated vehicle, the system including:

an emergency air supply line, in which is fitted a valve as defined in the first aspect of the invention.

All these embodiments share the advantage that the emergency trailer braking system is not deactivated until the driver is in the tractor unit, so any free-wheeling of the vehicle is preferably prevented. The valve according to the first aspect has the added advantage that the service braking system is activated when the emergency braking system is deactivated. This is simple for the driver. There is the further advantage of the valve that it may very conveniently be fitted to the air supply lines of existing trailers.

In further aspects, the present invention provides tractor units and/or trailers fitted with valves or systems according to the first two aspects.

Although in the above aspects it has been stated that the signal for the control means is derived from an electrical braking system of the vehicle, in other aspects it is envisaged that the signal may be derived from elsewhere. In other words, all that matters is that there is an electrical signal (taken from anywhere) which is capable of activating the control means.

### DETAILED DESCRIPTION

Embodiments of the present invention will now be described in more detail, by way of example only, with reference to the accompanying drawings, in which:

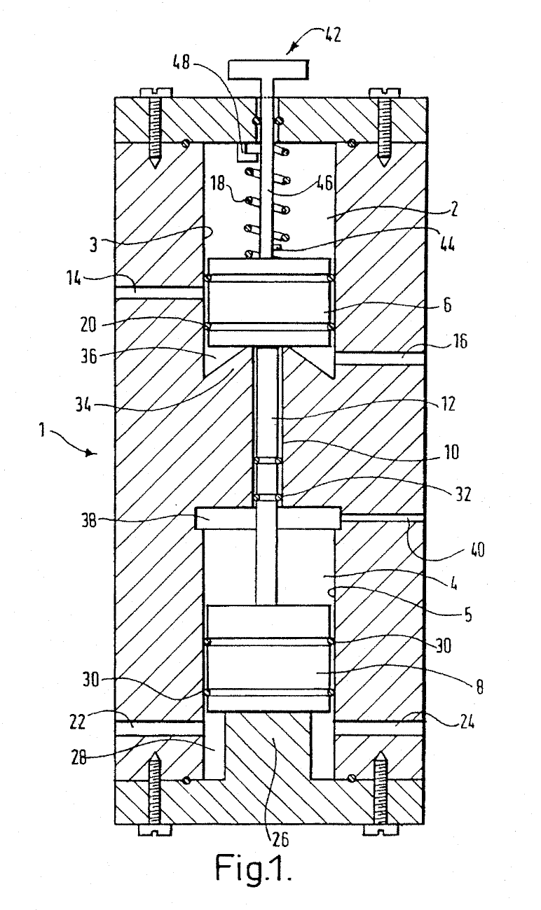

In FIG. 1 the valve 1 includes first and second chambers 2, 4, in which are slidable first and second pistons 6, 8, respectively. The pistons are aligned relative to each other along their respective directions of movement in the chambers. The chambers communicate via a narrow through-hole 10 in the valve, an axis of the through-hole also being aligned along the direction of movement of the pistons. A rod 12 is located in the through-hole 10 and may be used to transmit movement of the second piston 8 to the first piston 6, as will be described in more detail below.

In the following description, the valve is connected as described below to the red (emergency) and yellow (service) lines of an articulated vehicle. The function and operation of these lines is described in the introduction. However, in its broadest aspects, the invention is not to be construed as being limited to the valve thus connected. Furthermore, mechanical elements of the prior art valve described with reference to FIG. 1 may be utilised in similar ways in a valve according to the present invention, as appropriate.

The first chamber 2 has an inlet 14 and an outlet 16, which may be connected to the red line. The inlet 14 and outlet 16 will therefore be referred to as the “red” inlet and outlet. The valve includes connectors (not shown) adapted for airtight connection of the red inlet and outlet to corresponding connectors on the red line. Suitable connectors may for example include male and female threaded sleeves. The valve may be fitted on a trailer of an articulated vehicle.

The first piston 6 is biased by a helical compression spring 18 to a closed position, shown in FIG. 1, in which passage of air through the red inlet 14, first chamber 2 and red outlet 16 of the valve is prevented, thereby preventing passage of air along the red line. A seal 20 between the first piston 6 and a cooperating side wall 3 of the chamber 2 substantially eliminates leakage between the inlet and outlet when the piston is in the closed position.

The second chamber 4 has an inlet 22 and an outlet 24, which may be connected to the yellow line. The inlet 22 and outlet 24 will therefore be referred to as the “yellow” inlet and outlet. Again, the valve preferably includes connectors adapted for airtight connection of the yellow inlet and outlet to corresponding connectors on the yellow line.

The second chamber 4 includes a stop 26 which prevents the second piston 8 from blocking air passage through the chamber between the yellow inlet and outlet. As shown, the stop 26 includes a projection from an end wall into the bore of the chamber, leaving an annular space 28 in the chamber around the projection. The yellow inlet and outlet communicate with the annular space. Additionally or alternatively, the second piston may contain a through-hole to prevent restriction of the air flow between the yellow inlet and outlet.

Seals 30 between the second piston 8 and a cooperating side wall 5 of chamber 4 substantially eliminate leakage of air past the second piston 8. Under pressure in the yellow line (as occurs when a driver of the articulated vehicle depresses the brake pedal in the tractor unit), the second piston 8 is therefore pushed away from the stop 26 towards the other end of chamber 4.

A rod 12 is longitudinally aligned with the direction of movement of the pistons 6, 8 in the chambers 2, 4, such that movement of the second piston 8 in the second chamber 4 away from stop 26 imparts movement to the first piston 6 in the first chamber 2, against the bias of the spring 18, towards an open position in which passage of air between the red inlet and outlet is permitted.

Once the first piston 6 has been moved to the open position in the first chamber 2, and air passage between the red inlet and red outlet is permitted, high air pressure in the red line maintains the piston in the open position, against the bias of spring 18, until such time as the air pressure in the red line drops, whereupon the spring moves the first piston 6 back to the closed position, as shown in FIG. 1.

Because the valve prevents air passage between the red inlet and outlet when the first piston 6 is in its closed position, reconnection of the red line following disconnection does not immediately result in air being supplied from the tractor unit to an air tank in the emergency braking system of the trailer (see introduction above) to deactivate the emergency braking system. Rather, deactivation occurs only when the first piston 6 moves to its open position, which as described above depends on air being supplied along the yellow line.

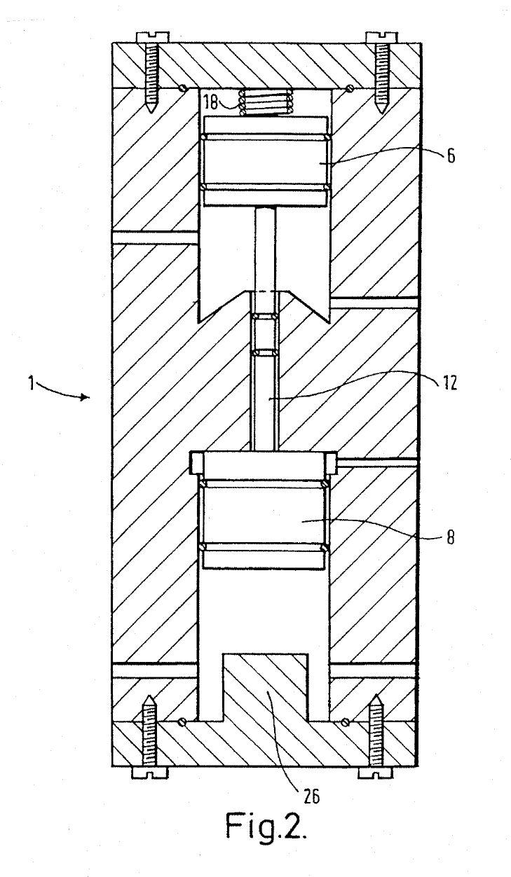

FIG. 2 shows a valve (or valve assembly) according to an embodiment of the present invention incorporated in part of the braking system of a vehicle. A main valve 1 includes an air inlet 22 and an air outlet 24 which, in use, will be connected to the red “emergency” line.

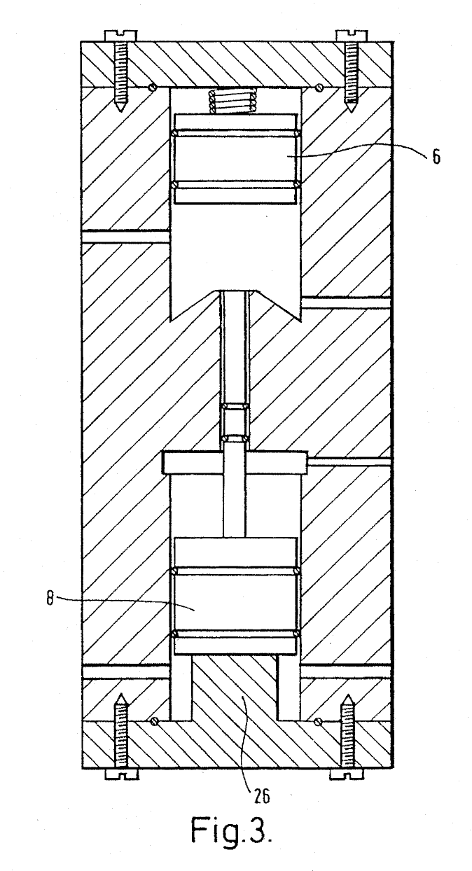

Inside valve 1, the connection between inlet 22 and outlet 24 is controlled by a valve member (shown in FIG. 3) which is biased to a closed position (i.e. air cannot pass between inlet and outlet), for example by spring means 2. The valve member may also be connected to operating means, which in this case is a main valve operating piston 11 located in an upper chamber in the valve 1. The internal arrangement of the valve member and piston etc. may be similar to that shown in FIG. 1.

The valve chamber 11 is in fluid communication with a start means 7, which in this case consists of an electrically operated one-way valve, with the one-way valve portion being shown by item 8. The one-way valve connects the upstream portion of the red line 6 to the chamber 11. The electrical feed for the operation of the start (or opening) valve is derived from a pressure switch 9, via connection 14. Pressure switch 9 is incorporated in part of the ordinary braking system 10 i.e. the yellow line. When the ordinary braking system is operated i.e. pressure is increased in the yellow line 10, the pressure switch 9 is activated and the start valve 7 receives an electrical signal and opens. This permits pressure from the red line 6 to be communicated to the chamber 11 and therefore the main valve 1 to be opened.

The chamber 11 is also in fluid communication with a pressure supply means 3, which in this case is a one-way valve. This supplies pressure to the chamber 11 from the downstream side of the red line 5. Thus, in use, when the red line is pressurised, chamber 11 will also be pressurised regardless of the state of start valve 7, thereby keeping the main valve 1 open.

Finally, chamber 11 is also in fluid communication with control means 4, which in this case is an electrically operated valve connecting chamber 11 to the downstream side of red line 5. The control means 4 derives its electrical supply from any suitable part of the vehicle electrical system. As mentioned before, this may, for example, be direct from the ignition system or indirectly from a part of a vehicle braking assistance system. In this case, positive supply 12 is taken from the ABS braking system line, where it is connected to pressure switch 9. With both of the electrically operated switches, there are suitable connections to earth (or negative supply) marked with numeral 13. In this way, as long as control means 4 is receiving a suitable electrical supply, the valve remains closed (not as shown in FIG. 2). This means that if, for example, pressure in either or both of the upstream and downstream red lines falls, one-way valves 3 and 8 will close and control means 4 will also be closed, thereby retaining pressure in chamber 11 and ensuring that the main valve 1 remains open. If the electrical supply to control means 4 is removed (e.g. the ignition is turned off or the ABS plug is not connected), the electrically operated valve will open and there will be little or no pressure in chamber 11. Therefore the main valve 1 will close and the emergency brakes will remain applied until the normal start up procedure is undergone.

In sequence, the operation of an example of a braking system incorporating a valve according to the present invention would be as follows:
1. Initially, all the brake lines (i.e. red lines and yellow lines) are connected and the ABS plug is coupled. At this point, the valve 1 is closed, therefore there is no pressure in the downstream side of the red line and the emergency brakes remain on.
2. The ignition is turned on, which provides power to control means 4 and closes the electrically operated valve. If this did not take place, no pressure could build up in chamber 11 and valve 1 could not open.
3. The engine is started and air pressure is built up in the system as normal.
4. The foot brake is applied. This activates pressure switch 9 which in turn supplied electrical power to the start up valve 7 and opens it. As previously explained, this enables pressure to build up in chamber 11 which opens valve 1, which allows pressure to pass into the downstream side of the red line, which in turn releases the emergency brakes.
5. The further valve 3 then opens because of the pressure in the downstream side of the red line, and this ensures that pressure will be maintained in chamber 11 even when the start valve 7 closes.
6. The foot brake is released, which turns off pressure switch 9 which in turn closes start valve 7.
7. The vehicle can be driven off.
8. During use, if for whatever reason pressure in the red line drops then the emergency brakes will be applied as they should. However, as previously explained, the operation of all the elements connected to chamber 11 is such that the pressure will remain in chamber 11 as long as the ignition is not turned off or the ABS plug removed. This enables pressure to be built up in the red line again, so that the emergency brakes can be released.

It will be noted that the trailer brakes cannot be released if:
1. The yellow line is not connected.
2. The red line is not connected.
3. The ABS lead is not connected or the ignition not switched on.
4. The yellow line is not under pressure (i.e. the hand brake or foot brake is not applied).

### These are all helpful safety features.

FIG. 3 shows a schematic cross sectional view through a main valve body 1 of FIG. 2. As can be seen more clearly, a piston 30 can be operated by pressure in the chamber 11. When there is little or no pressure in chamber 11 in the open position, the valve couples inlet 22 to outlet 24. The valve also has an additional, option feature, that in the closed position it couples outlet 24 to a vent 32, shown in FIG. 3. Therefore, when there is little or no pressure in chamber 11, the piston 30 is biased by spring 2 to the closed position, but when sufficient pressure is introduced into chamber 11, the piston is operated against the action of spring 2 so as to close the connection between vent 32 and outlet 24 and open the connection between inlet 22 and outlet 24.

The invention may include any variations, modifications and alternative applications of the above embodiments, as would be readily apparent to the skilled person without departing from the scope of the present invention in any of its aspects.

1. A valve for inclusion in an emergency air supply line to the trailer braking system of an articulated vehicle, the valve having:
an air inlet, connectable to an upstream side of the emergency air supply line;
an air outlet, connectable to a downstream side of the emergency air supply line;
a closing member, biased towards a closed position in which passage of air through the valve between the first air inlet and first air outlet is substantially prevented;
operating means for opening the closing member; wherein the valve also includes
control means for retaining the closing member in an open position on receipt of an electrical signal, the signal being derived from an electrical braking system of the vehicle.

2. A valve according to claim 1 wherein the operating means can only be activated if the control means is activated i.e. is receiving an electrical signal.

3. A valve according to claim 1 including start means which are activatable to operate the operating means on activation of a foot or hand brake of the vehicle.

4. A valve according to claim 3 wherein the start means are electrically operated.

5. A valve according to claim 4 wherein the electrical supply which operates the start is taken from a pressure switch which is operated by pressure to the yellow (normal braking) line.

6. A valve according to claim 3 wherein the start means includes opening valve means and is arranged so that when the start means is operated by a suitable electrical supply, the opening valve means open to permit air pressure to pass from the red line to the operating means.

7. A valve according to claim 1 including a further pressure supply means connected to or connectable to the air outlet or the downstream side of the emergency air supply line which further pressure supply means serves to permit pressure in the downstream side of the air supply line to be applied to the operating means in order to keep the operating means operating during operation of the vehicle.

8. A valve according to claim 1 wherein the control means also includes a control valve which in use connects the air outlet or the downstream side of the emergency air supply line to the opening means and while electrical power is supplied to the control means the control valve remains closed, thereby preventing pressure from escaping from the operating means.

9. A system for safely deactivating an emergency braking system of a trailer of an articulated vehicle, the system including an emergency air supply line, in which is fitted a valve according to any of the above claims.

10. A trailer fitted with a valve system according to claim 9.
